(19) United States
(12) Patent Application Publication
(10) Pub. No.: US 2003/0028535 A1
(43) Pub. Date: Feb. 6, 2003

(54) Call control system for video communication networks

(75) Inventors: Robert D. Sheldon, Austin, TX (US); Benton B. Maples, Austin, TX (US)

Correspondence Address: BAKER BOTTS L.L.P., PATENT DEPARTMENT, 98 SAN JACINTO BLVD., SUITE 1500, AUSTIN, TX, 78701-4039, US

(73) Assignee: Forgent Networks, Inc.

(21) Appl. No.: 10/062,168

(22) Filed: Jan. 31, 2002

Related U.S. Application Data
(60) Provisional application No. 60/309,131, filed on Jul. 31, 2001.

(51) Int. Cl. G06F 7/00

(52) U.S. Cl. 707/10

(57) ABSTRACT

The present disclosure describes a system and method for a call control system for managing a video network. The call control system includes a master gatekeeper that is able to associate with and manage multiple video network elements, including circuit switched video network elements and packet switched video network elements. The call control system also includes a call control database and a connection engine. The call control database stores registration and status information related to associated network elements. The connection engine analyzes conference call requests and determines the appropriate connection required for the associated network element.

### CROSS REFERENCE TO RELATED APPLICATION

This application claims priority from U. S. Provisional Patent Application Serial No. 60/309,131 filed Jul. 31, 2001 and entitled Method and System for a Video Network Virtual Gatekeeper.

### TECHNICAL FIELD OF THE INVENTION

The present invention relates in general to the field of communication networks and specifically to a call control system for managing video communication networks and methods of use thereof.

### BACKGROUND OF THE INVENTION

Video communication networks often include network equipment of varying age, made by many different vendors, and designed to operate on different network infrastructures and protocols. Video calls or conferences can typically be placed through numerous distinct network paths and often require using specific transmission speeds and algorithms in order for various network elements to communicate properly. Many networks are so-called “hybrid networks” consisting of both circuit switched networks (compliant with International Telecommunication Union (ITU) standard H.320), and packet-switched networks (compliant with ITU standard H.323).

Determining the optimal network path and optimal algorithms for transmitting information in such a network is often a complicated manual process yielding less than desirable results.

The process of placing a call manually typically requires a user to find a correct network address or number to dial, and then hoping the resources are available. When a connection is made, monitoring calls across different types of systems, networks, and infrastructure equipment is often not possible. Accordingly, without being able to monitor and track when calls are made and which resources were required to make the calls, incorporating all of the elements of a video communications network into network billing and diagnostic systems is not practical.

Furthermore, many organizations have networks incorporating systems and network elements from different vendors. Placing calls in such a hybrid video communications network generally requires a user to have knowledge of multiple videoconferencing systems and their respective user interfaces. Further complicating this is the fact that the different systems may operate on different types of networks such as ISDN and TCP/IP networks. For instance, to properly place a point-to-point call on some hybrid networks, a user must be experienced with the native user interface of the system, and also with the underlying network infrastructure. When confronted with an ISDN number to call, a user of a TCP/IP system will have to understand the different calling format, and how to connect to a gateway to bridge the ISDN and TCP/IP networks together.

These difficulties in establishing a connection between video network endpoints can hamper effective utilization of a video network. This inefficiency increases the cost of communication because potential users may be reluctant to attempt to establish a call or unable to establish a call because they do not possess adequate background knowledge of the system. In the event that a call is attempted, it may fail because the desired network endpoint may not be available, leading to further frustration and disuse, and corresponding waste of valuable resources.

### SUMMARY OF THE INVENTION

Therefore, a need has arisen for a call control system that facilitates the operation of a hybrid video network.

A further need has arisen for a system for facilitating billing and usage reporting in a video network.

A still further need has arisen for a simplified user interface that facilitates the initiation of video conferences between two or more network endpoints.

In accordance with teachings of the present disclosure, a system and method are described for a call control system for managing a video network. The call control system includes a master gatekeeper that is able to associate with and manage multiple video network elements, including circuit switched video network elements and packet switched video network elements. The call control system also includes a call control database and a connection engine. The call control database stores registration and status information related to associated network elements. The connection engine analyzes conference call requests and determines the appropriate connection requirements for the requested conference call.

More particularly, the master gatekeeper operates to identify and register each associated network element. The master gatekeeper also receives call requests and issues directives to associated network elements. Additionally, the master gatekeeper may query associated network elements at selected time intervals to update the status of each element.

The Master gatekeeper advantageously provides a broad registration and permission system for video networking equipment, including H.320 and H.323 devices and applications. The network elements registered by the Master gatekeeper include: videoconferencing endpoints, gateways, MCUs, gatekeepers and network infrastructure equipment such as routers, switches, Data Communications Equipment (DCEs), and Channel Service Unit/Data Service Units (CSU/DSUs). DCEs may include modems and CSU/DSUs often connect to LANs and WANs. The Master gatekeeper may also place calls and terminate calls based on user access privileges and network status. The master gatekeeper extends the conceptual capabilities of an H.323 zone to an entire video network, including legacy H.320 equipment, and also provides ease of use benefits to both video network administrators and end users. In addition to registration of network elements, the master gatekeeper preferably communicates with the network elements, obtaining status information and issuing commands.

In one aspect, the present invention includes a master gatekeeper for a call control system that includes a registration module, a network status module, and a command engine. The registration module identifies and registers associated circuit switched video network elements and packet switched video network elements. The network status module queries associated network elements to determine that status of associated network elements. The command engine issues directives to associated network elements. More particularly, the master gatekeeper may include an accounting module for recording network usage information and generating billing reports.

In another aspect, the present invention includes a network user interface for a video network call control system displayed on a network enabled device. The network user interface includes a login field for receiving user identification information. The network user interface also provides a call request field that functions to allow the user to select which endpoints within the associated video network are desired to place the call. The requested video conference endpoints may be identified by submitting identification information including an alias, a network address , an E.164 type extension, or another suitable identifier. In addition to the call request field, the network user interface provides a list of endpoints that a user may call from a particular system. From this list a user may call an endpoint or create a multipoint call by selecting names from the list.

The network user interface allows end users to place calls through the call control system. This network user interface may be HTTP based such that a server-generated user interface is displayed on a network-enabled device such as a web browser or PDA. The network user interface simplifies the calling procedure by eliminating any need to know phone numbers, IP addresses, line speeds or compression algorithms. If an end user bypasses the network user interface, and places an ad-hoc call through the native interface of a videoconferencing device, the master gatekeeper may terminate the call, since it was not verified through the access system of the call control engine. This capability enhances network security and stability and demonstrates how the master gatekeeper can apply security functions to an entire video network, whereas existing gatekeepers such as H.323 n gatekeepers can only provide security functions to a limited zone.

The present invention provides a number of important technical advantages over prior systems for managing video networks. By identifying and registering both circuit switched and packet switched video network elements, the call control system facilitates the operation of hybrid video networks. Providing a gatekeeper with an accounting module supports billing and usage reporting in a video network. Also, the network user interface disclosed in the present invention simplifies the process of initiating a video conference between two or more network endpoints, promotes the effective use of network resources, and aids in the selection of routes within the network. Further advantages of the present invention are described in the figures, claims, and description below.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 shows a call control system according to the present invention;

FIG. 2 shows a call control system with a master gatekeeper managing a plurality of video network elements;

FIG. 3 shows a call control system including a master gatekeeper, a call control database, and a connection engine;

FIG. 4 shows a network user interface and call control system according to the present invention; and

FIG. 5 shows a flow diagram of the operation of a call control system according to the present invention.

### DETAILED DESCRIPTION OF THE INVENTION

Preferred embodiments and their advantages are best understood by reference to FIGS. 1 through 5, wherein like numbers are used to indicate like and corresponding parts.

Now referring to FIG. 1, a communications network, depicted generally at 10, including call control system 12, according to the present invention. Call control system 12 includes master gatekeeper component 14 which may also be referred to as a ‘king’ gatekeeper or ‘virtual’ gatekeeper. Master gatekeeper 14 preferably registers and manages a plurality of associated network elements. Call control system 12 further includes call control database 16 and connection engine 18. Call control database functions to store registration data related to the associated elements and other selected information related to communications network 10. In a preferred embodiment, master gatekeeper 14, call control database 16, and connection engine 18 are embodied as software applications operable to interface with one another and call control system 12. Alternatively, master gatekeeper 14, call control database 16, and connection engine may be embodied as a combination of hardware and software elements.

Call control system 12 preferably generates Network User Interface (NUI) 20 based on the information stored in call control database 16. NUI 20 preferably allows a user, such as end user 22, to initiate a video conference between selected network endpoints. Call control system 12 is also operably connected to video network elements via network 24.

In the present embodiment, call control system 12 connects to video network endpoint 28, a circuit switched end point operating according to ITU standard H.320, via network 24. Additionally, one or more packet switched network elements within H.323 zone 26 are also operably connected to call control system 12 via network 24. H.323 zone 26 may include multiple H.323 video network endpoints within the zone of a H.323 compliant gatekeeper component. While FIG. 1 includes only enpoint 28 and zone 26, for demonstration purposes, the present invention contemplates call control system 12 connecting with a plurality of H.320 compliant and H.323 compliant network elements.

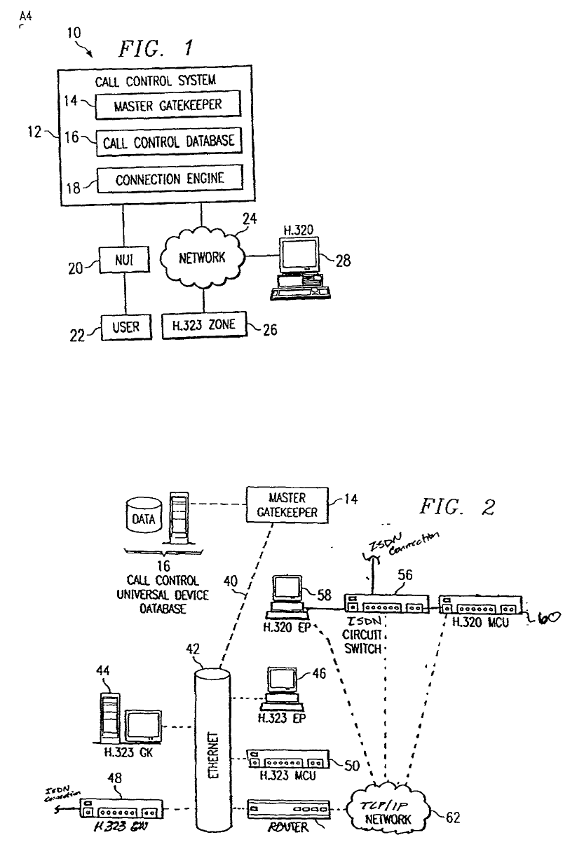

Now referring to FIG. 2, an alternate communications network according to the present invention. FIG. 2 shows a number of connections, in the present embodiment, dashed lines refer to TCP/IP connections and solid lines refer to ISDN connections. In the embodiment shown in FIG. 2, master gatekeeper 14 preferably connects with call control database 16. The connection between master gatekeeper 14 and call control database 16 may be through a physical connection such that master gatekeeper 14 and call control database 16 are located in the same physical location or may be made through a network connection such that master gatekeeper 14 and call control database 16 are maintained remotely from one another. Further, master gatekeeper 14 connects with ethernet 42 via connection 40. In an alternative embodiment, ethernet 42 may be any suitable IP network such as a Token Ring or ATM. Connection 40 (shown as a dashed line) may include a TCP/IP connection operable to use Telnet, HTTP, native APIs, SNMP and other suitable protocols. Ethernet 42 provides access to a plurality of video network components including gatekeeper 44, endpoint 46, gateway 48, Multipoint Control Unit (MCU) 50, and Router 52. In the present embodiment gatekeeper 44, endpoint 46, gateway 48, and MCU 50 operate on a packet switched network compliant with ITU standard H.323. In a preferred embodiment, gateway 48 includes has an ISDN network connection as well a TCP/IP connection to Ethernet 42. The H.323 components may communicate with components in other networks through router 52 and network 62. Master gatekeeper 14 may use a variety of methods to communicate with devices across the network such as: APIs provided by the devices, HTTP, Telnet and SNMP.

Master gatekeeper 14 may communicate with H.320 network components 56, 58 and 60 via ethernet 42 and homogeneous network 62. Homogeneous network 62 is preferably an IP network. More particularly, homogeneous network 62 is preferably a TCP/IP network. Endpoint 58 and H.320 MCU are preferably connected to ISDN circuit switch 56 through an ISDN connection.

Often in H.323 videoconferencing, which encompasses videoconferencing over IP networks, a gatekeeper component generally controls permission and access for H.323 elements defined within its zone. This permits advantageous control and monitoring within an H.323 zone, because the gatekeeper acts as the authority within that zone. Accordingly, gatekeeper 44 may include the associated H.323 components in a H.323 zone. In the present embodiment, master gatekeeper 14 preferably identifies and registers the associated H.320 compliant network elements and stores the registration information in call control database 16.

An H.323 zone is the collection of H.323 terminals, MCUs and gateways registered with a particular gatekeeper.

The master gatekeeper described performs similar services for H.320 equipment. It also registers H.323 equipment, and controls H.323 gatekeepers, thereby making it the master gatekeeper of all the associated H.323 zones, and all the associated H.320 devices on the network. Master gatekeeper 14 preferably uses H.323 gatekeepers to control a particular H.323 zone.

As described above, master gatekeeper 14 also communicates with endpoint 58 which is compliant with ITU standard H.320 compliant circuit switch 56, and H.320 compliant multipoint control unit 60. In the present embodiment master gatekeeper 14 preferably identifies and registers network components H.320, endpoint 58, ISDN circuit switch 56, and H.320 MCU 60. After registering the network components, registration information may preferably be stored in call control database 16.

In the present embodiment master gatekeeper 14 consists of software running on a server that communicates with and may control the associated video network devices. The master gatekeeper also registers associated video network devices in order to maintain call control database 16, listing the capabilities of associated network devices as well as their current state. Master gatekeeper 14 communicates with the associated network devices through a variety of methods, depending on the type of device. Master gatekeeper 14 may communicate with and control devices through interfaces such as: an SNMP interface, an HTTP interface, a Telnet interface or another suitable interface.

The devices that master gatekeeper 14 associates with and registers may include: H.323 Gatekeepers, such as gatekeeper 44, H.323 videoconferencing endpoints such as endpoint 46, voice over IP endpoints, H.320 videoconferencing endpoints such as endpoint 58, H.320 Multipoint Control Units such as MCU 60, H.323 Multipoint Control Units such as MCU 50, H.320 to H.323 gateways such as gateway 48, Telephony devices such as PBX's and circuit switches, and Network access equipment.

Master gatekeeper 14 preferably updates call control database 16 of capabilities and status of associated network devices. Call control database 16 may be populated manually in some instances, but is preferably maintained through master gatekeeper 14's continual communication with the devices. At a given time interval, the master gatekeeper 14 queries each associated device and updates call control database 16 appropriately so that the call control database 16 maintains an accurate representation of the current status of the associated devices.

For each type of associated network device, a different set of registration and status information is maintained. The registration and status information maintained for each type of device will be particular to the functions of each type of device.

For each H.323 Gatekeeper component, call control database 16 preferably stores the IP address of the gatekeeper, the IP address of each registered node, the E.164 address of each registered node, the Alias of each registered node, an identification of any neighbor gatekeeper, and the call status of each registered node.

For each associated H.323 Videoconferencing endpoint, including VOIP phones, call control database 16 preferably maintains the IP address of the endpoint, bandwidth capabilities of the endpoint, supported algorithms, an associated gatekeeper, an alias, an E.164 address, the call status of the endpoint, and a forwarding address.

For each associated H.320 Videoconferencing endpoint call control database 16 preferably maintains the IP address of each endpoint, the ISDN numbers for each endpoint, the call status of each endpoint, the algorithms supported by each endpoint, the bandwidth capabilities of each endpoint, and a forwarding address for each endpoint.

For each H.320 MCU, call control database 16 maintains the MCUs IP address, ISDN number, conference status, 30 bandwidth capabilities, and supported algorithms.

For each H.323 compliant MCU, call control database 16 maintains the MCUs IP address, conference status, services (such as service prefixes), bandwidth capabilities, and supported algorithms.

For associated H.323 to H.320 Gateway, call control database 16 maintains the gateway's IP address, ISDN number, port status, call status, and services.

For each associated circuit switch, call control database 16 maintains the E.164 numbering plan, the directory of services, the port status, and the bandwidth allocations of the circuit switch.

Also, for each unit of network access equipment call control database 16 maintains IP address, port, and port status for each unit.

Master gatekeeper 14 communicates with all of the associated network devices, and provides call control database 16 with current information for associated devices and their status within the video network. Call control database 16 is linked to master gatekeeper 14 through constant updates. Call control database 16 contains status, as well as a detailed record log of usage for all devices associated with master gatekeeper 14. Call control database 16 also contains user information and access privileges. The master gatekeeper 14 may issue commands to associated devices, including placing calls and terminating calls. If master gatekeeper 14 detects that an associated device is in use, but that the device should not be in use (for example, if an ad-hoc call was placed through the native interface of a videoconferencing system), master gatekeeper 14 may instruct the associated devices to terminate the call.

Master gatekeeper 14 updates call control database based on master gatekeeper's 14 communication with the associated devices. This database includes the fields listed above related to various devices, as well user data and privileges. Master gatekeeper 14 connects with associated network devices via connection 40, preferably a connection over a TCP/IP network. In the present embodiment all devices are accessible via TCP/IP through the same data network, although they use other network paths for video communications. Connection 40 may include communication through SNMP in some cases, HTTP, Telnet, APIs, or any other method of access suitable to a particular device.

Master gatekeeper 14 preferably continually monitors the associated network devices to assure that the database is accurate, and issues commands to associated devices when required. For example, consider a call between H.320 endpoint 58 and H.323 endpoint 46. Endpoint 46 places a call through gateway 48, which then connects through gateway's 48 ISDN connection to a public ISDN network (not depicted) and then to ISDN circuit switch 56. In this call, master gatekeeper 14 will update the database to represent the existing state of the network, with the appropriate ports on the associated devices that are in use from this call being noted within the database.

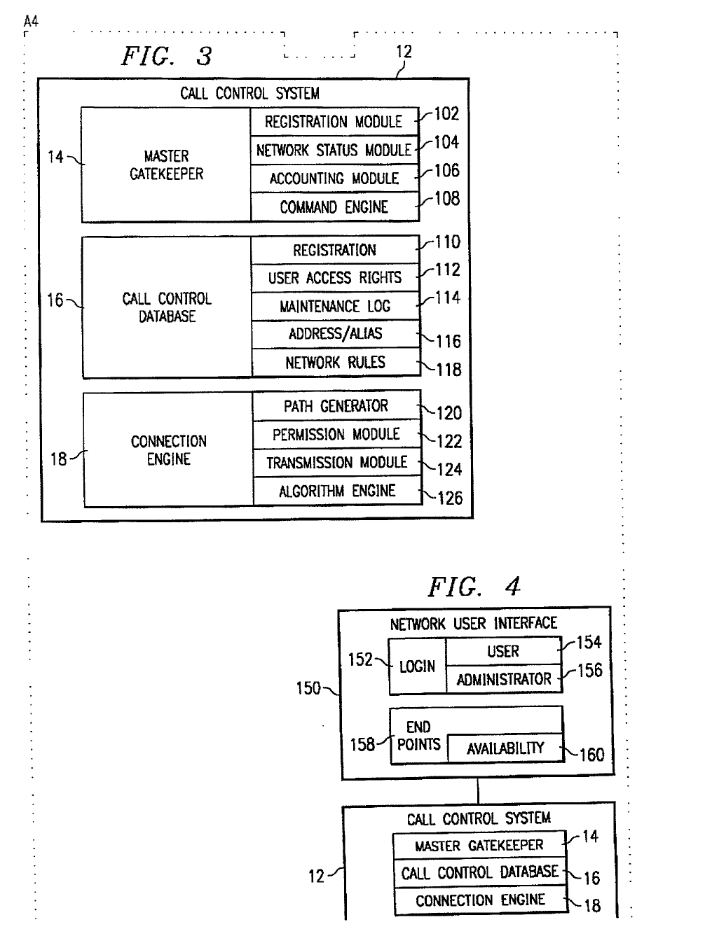

Now referring to FIG. 3, a call control system including a master gatekeeper, a call control database and a connection engine according to the present invention is shown.

Call Control system 12 includes master gatekeeper 14, call control database 16, and connection engine 18. Master gatekeeper 14 preferably includes registration module 102, network status module 104, accounting module 106, and command module 108. Call control database 16 includes registration data 110, user access rights information 112, maintenance logs 114, address and alias information 116, and network rules 118.

Connection engine 18 includes path generator 120, permission module 122, transmission module 124, and algorithm engine 126.

In the present embodiment, registration module 102 of master gatekeeper 14 acts to query associated network devices for registration information, as described above. Network status module 104 functions to query associated network devices either at selected intervals or in response to particular network actions (such as call requests) to determine the status of each associated network device. Accounting module 106 functions to monitor and record the status of each associated device for accounting and billing purposes. Finally, command engine 108 preferably acts to generate commands to be issued by master gatekeeper 14, such as commands to terminate an existing call.

Call control database 16 includes various information including registration information 114, address and alias information 116, and network rules 118. Registration information 114 may include a description of the type of associated network component, the status of each component, and information pertaining to the location of the associated device such as neighboring component information. User access rights data 112 preferably includes information such as user identifications, user names, authorization levels, user aliases, and user passwords. Maintenance log 114 includes information such as down time for a particular associated component. Address and alias information data includes, for each associated network, addresses such as an IP address, E.164 extension, and ISDN number, where appropriate, as well as component aliases or any other suitable address or component identifier.

Connection Engine 18 queries call control database 16, and instructs master gatekeeper 14 on how to place a call. Call control database 16 preferably contains a matrix representing the video network, and possible paths from one associated network device to any other associated network device.

In the present embodiment the “possible path” or “network path” refers to all of the associated devices and ports used to create a video call, both point-to-point and multipoint.

In operation, when a video call is placed, connection engine 18 queries the call control database 16 to determine what associated devices, permissions, speeds and algorithms are available. Connection engine 18 selects the network path, permissions, speeds and algorithms according to existing rules such as those stated in rules database 118 as well as the rules maintained within its internal modules.

In the event that an endpoint has been specified to forward calls, connection engine 18 obtains this information from call control database 14, and places the call to the forwarded endpoint, rather than the endpoint specified.

In the present embodiment, connection engine 18 includes path generator 120, permission module 122, transmission module 124 and algorithm engine. Path generator 120 functions to select a preferable network path to place a call between specific end points. Permission module 122 functions to verify that a user has appropriate authorization to place a call and has provided a valid user identification and password. Transmission module 124 selects an appropriate transmission speed for a call and algorithm engine 126 selects appropriate transmission algorithms for the call.

When a user places a call (for example by submitting a request via a network user interface as shown in FIG. 1), the following occurs: first, connection engine 18 is notified by master gatekeeper 14 of the call attempt. Second, connection engine 18 queries call control database 16 to assure that the call initiator has appropriate access. If the requesting user does not have appropriate access, call control engine 18 denies the call. Next, connection engine 18 queries call control database 16 for possible paths for the call. Connection engine 18 then queries call control database 16 about each network path and, whether the resources necessary for each path are available, whether the appropriate access rights exist for all the devices in each path, and what the algorithm capabilities of the devices in each path. Next call control engine 18 determines which route is most appropriate based on rules defined by a system administrator. Call control engine 16 then preferably instructs master gatekeeper 14 to initiate the call with the appropriate speeds, algorithms, and network infrastructure devices.

In the present embodiment, the selection of the appropriate route is based on rules defined by an administrator. Such rules will allow an administrator to assure that certain devices are used by default, while others are only used out of necessity. For example, an administrator may set preferences for H.320 vs. H.323 devices, and for the speeds and algorithms that are most desired. Using these rules, call control engine 12 will preferably evaluate each connection path, speed, algorithm, and so forth, and select the one that conforms most to the rules set forth by an administrator. Because no two networks are the same, and the preferred resources of each network will be different the rules for each network may be selectively added, removed or amended by a system administrator. In some cases, an administrator might have two identical pieces of equipment, and wish to use one only as a backup. In this case, an administrator could formulate the rule to use the first piece of equipment over the second, unless the first was unavailable.

Now referring to FIG. 4, a Network User Interface (NUI) depicted generally at 150 and a call control system according to the present invention. As described above, call control system 12 includes master gatekeeper 14, call control database 16 and connection engine 18. Call control system 12 is operably connected with Network User Interface (NUI) 150. NUI 150 preferably includes login utility 152. In the present embodiment login 152 provides login functions for users 154 and administrators 156. NUI 150 further provides endpoint selection module 158 and end point availability module 160 integrated therein. Generally, after a user or administrator logs in, NUI 150 allows the user to select the endpoints and to view the availability of the desired endpoints via endpoint module 158 and availability module 160. Access to administrators 156 will advantageously facilitate the effective management of the network by network administrators.

In the present embodiment NUI 150 is preferably generated by a server application that queries call control system 12. NUI 150 is then provided to generate NUI 150 to aid users in placing video calls. In the present NUI is HTTP-based, and may preferably be made available through a web browser running on a videoconferencing system or on a PC located in the room with a video conferencing system. In an alternate embodiment, NUI 150 may be run on a wireless PDA, such as a PalmPilot, connected to the network.

The NUI 150 provides a login system 152 such that users may log in and place calls according to their access rights. In many cases, a user may be defined by the endpoint or physical location where the call is initiated. Accordingly, any user placing a call from that location will be logged in with standard privileges for anyone using that system in that physical location. Alternatively, user identifications may be specific to individuals authorized to place calls on the system.

NUI 150 may provide different information for different types of users. Typically, a network administrator has greater privileges than other users, and receives much more detailed information about the status of the network, the devices on the network, as well as a much broader range of commands than are available to the typical end user. For example, a network administrator might have the ability to terminate any call in progress, or set call forwarding on a system. Access to this information allows a network administrator to manage the network. In the present embodiment, a regular user may login via the user module 154 and an administrator may login via administrator login 156.

NUI 150 provides individual users with a utility to place calls. After login in, NUI 152 provides users a list of association endpoints 158 that may be contacted. Additionally, availability module 160 may display the status of the endpoints before the call is attempted. Accordingly, users may place H.320 and H.323 calls without significant familiarity with the underlying network. NUI 150 will preferably allow users to place multipoint calls by simply selecting the endpoints 158 provided. In an alternative embodiment NUI 150 may allow users to schedule a future call.

NUI 150 simplifies the calling process, as users no longer have to retain phone numbers, IP addresses, service codes, or maintain address books. Use of NUI 150 does not require an understanding of the differences between ISDN and TCP/IP calling. NUI 150 also relieves user from selecting the correct line speeds or algorithms and understanding gateway dialing, or MCU configuration in order to place a call.

After a call has been submitted to NUI 150, the call is forwarded to and placed by connection engine 18. As described above, connection engine 18 derives the status of the possible connection routes from call control database 16, evaluates which resources should be used and how the calls should be placed according to the rules set by the administrator. After connection engine 18 determines the appropriate parameters of a call, including which MCUs and gateways if any, should be used, connection engine 18 directs master gatekeeper 14 to place the appropriate call by issuing the commands directly to the associated network devices.

NUI 150 reduces the complexity of placing calls by eliminating the need for users to obtain and retain phone numbers, addresses or aliases. NUI also relieves users of distinguishing between H.320 and H.323 devices, knowing appropriate transmission speeds and algorithms and protocols related to gateway dialing. Additionally, NUI 150 allows a user to make MCU calls without understanding the underlying technology of MCU configuration.

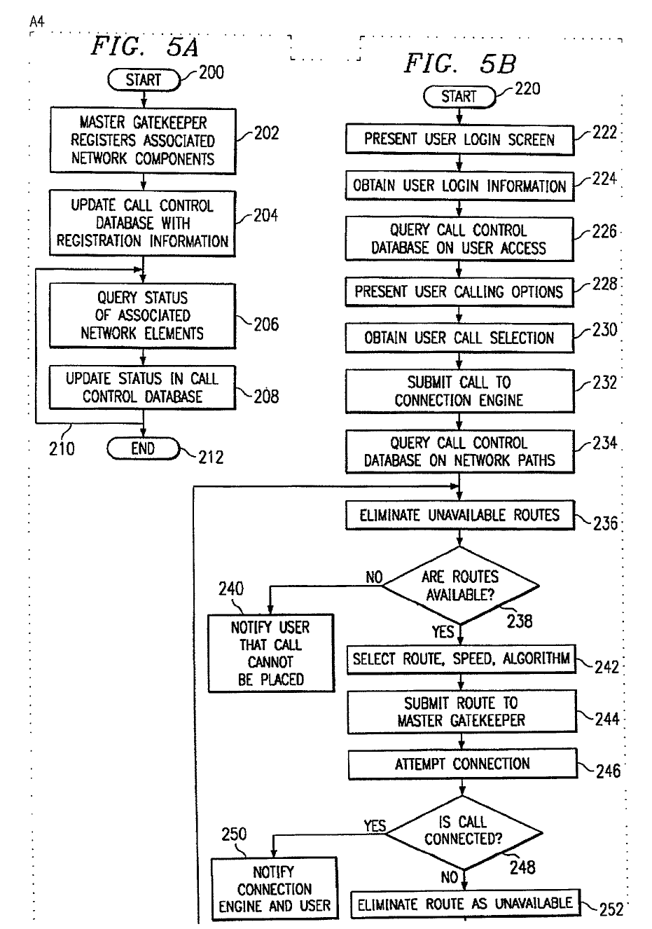

Now referring to FIG. 5A, a flow diagram of a call control system according to the present invention. The operation begins at 200 wherein the master gatekeeper registers associated network elements 202. Next, the call control database 18 updated with the registration information 204. The master gatekeeper may then query the associated network elements 206 to determine their current status. The current status of each associated element may then be updated 208 to reflect its current status. The querying of the network elements may be repeated periodically 210 to maintain current status information for associated components.

Now referring to FIG. 5B, a flow diagram showing the initiation of a video conference on a video network according to the present invention. First, a network user interface presents a user with a login screen 222, through a web browser, PDA, or another suitable network device capable of displaying the network user interface. In many cases, a videoconferencing endpoint or room may be continuously logged in as a user, and the process might skip the login step and begin at step 220. Next, the user inputs login information 224. The Network User Interface queries the call control database 226 to determine the access privileges of the user, the user's calling capabilities, and the status of the network. The call control database then returns the user's access privileges (if any), calling capabilities, and network status.

With the information received from the call control database, the NUI then presents the user with a calling interface that includes the names of the endpoints the user can call, as well as the status of those endpoints 220. The user may then submit the desired call request 230. For instance, the user may decide to make a three-way multipoint call by selecting the endpoint he is calling from and two additional endpoints from the user interface. The NUI may then pass the call submission to the connection engine 232. The connection engine then queries the call control database about potential network paths, the status and capabilities of devices within the path, and the access rights of the user and each device 234. The call control database returns the information requested by the connection engine.

The connection engine may eliminate any potential network path that the user cannot use because a device is in use, or because the user does not have access rights for a given device. It is then determined whether any connection paths or routes are available 238. If there are no possible connection paths, the connection engine reports this to the user via the NUI 240. If there are multiple potential connection paths, the connection engine evaluates each, and chooses one according to the rules provided by the administrator 242. The connection engine then selects speeds and algorithms according to the capabilities of the chosen network path, and more rules defined by an administrator. The connection engine sends the calling command to the master gatekeeper to issue to the chosen associated network devices 244. The master gatekeeper issues the commands to the selected network devices to place the call 246. The master gatekeeper then determines whether the command was successfully executed or not 248. If the call was successfully placed, the master gatekeeper reports this result to the connection engine and NUI 250. If the master gatekeeper was not able to place a call, the Connection Engine returns to step 236 minus the path that was attempted and failed 252. If no other paths exist, the connection engine reports to the NUI that the call could not be completed 240.

The present invention includes a number of important benefits in a video communications network. These benefits include monitoring access rights and privileges for end users and systems/rooms and extending H.323 gatekeeper-type capabilities to hybrid H.320 and H.323 video networks. The present invention also facilitates improved call reporting and record keeping. Security for controlling access to devices is improved by allowing the master gatekeeper to terminate calls that are made without proper access.

Also, call forwarding features are extended to a hybrid network and call routing and set up based on resource availability and rules defined by an administrator is facilitated. The NUI allows for simplified dialing relieving users from understanding many network complexities. The NUI also provides a dynamic, real-time view of those systems they can call and their status and provides a common interface for use with systems of many vendors. Also, an administrator has access to complete network status, error notification, and provides significant control of calls. Because of this increased access, the present invention provides a network administrator with the information necessary to better manage the network, thereby increasing the effectiveness and usefulness of the network.

Although the disclosed embodiments have been described in detail, it should be understood that various changes, substitutions and alterations may be made to the embodiments without departing from their spirit and scope.

What is claimed is:

1. A call control system for managing a video network comprising:
a master gatekeeper operable to associate with and manage a plurality of video network elements, the video network elements comprising circuit switched video network elements and packet switched video network elements;
a call control database operable to store registration and status data related to associated network elements; and
a connection engine operable to determine appropriate connectivity for associated network elements.

2. The system of claim 1 wherein:
the circuit switched video network elements further comprise H.320 compliant video network elements; and
the packet switched video network elements further comprise H.323 compliant video network elements.

3. The system of claim 1 wherein the associated video network elements are selected from the group consisting of:
end points, bridges, gateways, gatekeepers, and network access equipment.

4. The system of claim 1 wherein the associated video network elements further comprise at least one H.320 compliant video network element and at least one H.323 compliant video network zone.

5. The system of claim 1 further comprising the master gatekeeper operable to:
identify and register each associated network element;
receive call requests;
query associated network elements to determine status information; and
issue directives to associated network elements.

6. The system of claim 5 further comprising the master gatekeeper operable to identify and register at least one applications available on each associated element.

7. The system of claim 5 further comprising the master gatekeeper operable to query associated network elements at selected intervals to determine status information and storing the updated status information.

8. The system of claim 5 further comprising the master gatekeeper operable to query selected associated network elements to determine status information in response to specific requests.

9. The system of claim 5 further comprising the master gatekeeper further operable to establish a control zone having H.320 compliant components and H.323 compliant components.

10. The system of claim 5 further comprising the master gatekeeper further operable to receive call requests from a network user interface.

11. The system of claim 5 further comprising the master gatekeeper operable to direct an associated network element to connect a call.

12. The system of claim 5 further comprising the master gatekeeper operable to direct an associated network element to terminate a call.

13. The system of claim 1 further comprising the call control database operable having user information including user rights and privileges.

14. The system of claim 1 further comprising the call control database listing the applications available for each associated network element.

15. The system of claim 1 further comprising the call control database listing the status of each associated network element.

16. The system of claim 1 further comprising the call control database listing the maintenance/reliability information for each associated network element.

17. The system of claim 1 further comprising the call control database listing the usage records for each associated network element.

18. The System of claim 1 further comprising the call control database having identification listing for each network element including one or more aliases, an E.164 extension, and a network address.

19. The system of claim 1 further comprising:
the call control database having a listing of network usage by user; and
the gatekeeper operable to selectively generate a usage report for each user.

20. The system of claim 19 further comprising the gatekeeper operable to generate a billing report for each user.

21. The system of claim 1 further comprising the connection engine operable to maintain network rules.

22. The system of claim 21 wherein the network rules comprise selectively revisable network rules.

23. The system of claim 1 further comprising the connection engine operable to determine network path for a call between elements within the network based upon the network rules.

24. The system of claim 1 further comprising the connection engine operable to determine a network path for a call between network elements based upon the status of elements within the network and the permission associated with the user requesting the call.

25. The system of claim 1 further comprising the connection engine operable to determine appropriate transmission rates and algorithms for a call between components within the network.

26. A master gatekeeper for a call control center comprising:
a registration engine operable to identify and register associated circuit switched video network elements and packet switched video network elements;
a status engine operable to query associated network elements to determine status information; and
a command engine operable to issue directives to associated network elements.

27. The master gatekeeper of claim 26 further operable to:
receive a call request from a network user information; and
determine an appropriate response to a call request.

28. The master gatekeeper of claim 27 further operable to:
submit a call request to a connection engine;
receive a response from the connection engine; and
direct associated network elements to connect a call in accordance with the response received from the connection engine.

29. The master gatekeeper of claim 26 wherein the command engine is operable to:
direct an associated network element to connect a call; and
direct an associated network element to terminate a call.

30. The master gatekeeper of claim 26 further comprising an accounting engine operable to record network usage data and selectively generate billing reports from the network usage data.

31. A call control database for a call control system comprising:
a listing of registration data of associated circuit switched video network elements and associated packet switched video network elements;
a listing of user access rights; and
the call control database operable to provide registration data and access rights information to a call control system.

32. The call control database of claim 31 further comprising a listing of capabilities for each associated network element.

33. The call control database of claim 31 further comprising a status for each associated network element.

34. The call control database of claim 31 further comprising a listing of downtime for each associated network element.

35. The call control database of claim 31 further comprising an identification listing for each associated network element having an alias, a network address, and an E.164 extension.

36. The call control database of claim 31 further comprising a listing of network connection rules.

37. A Connection engine for a call control system comprising:
a path generator operable to determine a route for a call between associated network components;
a permission engine;
a transmission generator operable to determine transmission algorithms for a call between associated network components; and
an algorithm engine operable to determine transmission algorithms for a call between associated network components.

38. A network user interface for a video network call control system operable to be displayed on a network enabled device comprising:
a user input field for receiving user identification information; and
a call request input field for submitting at least two video conference terminals, the requested video conference terminals identified by submitting identification information selected from the group consisting of alias identification, network address information, and E.164 extension information.

39. The network user interface of claim 38 wherein the network enabled device further comprises a web browser.

40. The network user interface of claim 38 wherein the network enabled device further comprises a personal digital assistant.

41. A method for managing a video network comprising:
registering associated circuit switched network elements and packet switched network elements;
storing registration data in a call control database;
storing user permission data in a call control database;
receiving a request from a network user interface for a video conference between at least two associated network elements;
processing the received video conference request in a master gatekeeper;
determining a network path for a call request in a connection engine; and
directing selected associated network elements to place a call in accordance with the received request.

42. The method of claim 41 wherein processing the received video conference request further comprises:
determining user permission level;
determining the permission level required to connect the requested video conference; and
comparing the required permission level with the user permission level.

43. The method of claim 42 wherein processing the received video conference request further comprises:
determining at least one network path to connect a requested video conference; and
determining the availability of the required associated network elements on the at least one network path.

44. The method of claim 43 wherein determining the availability of associated network elements includes querying each required associated network element to determine availability.

45. The method of claim 41 further comprising periodically querying associated network elements to determine the status of the associated network elements.
